(19) United States
(12) Patent Application Publication
(10) Pub. No.: US 2007/0162968 A1
(43) Pub. Date: Jul. 12, 2007

(54) Rule-based network address translation

(76) Inventors: Andrew Ferreira, Holmdel, NJ (US); Lawrence Edwin Menten, Short Hills, NJ (US)

Correspondence Address: Ryan, Mason & Lewis, LLP, 90 Forest Avenue, Locust Valley, NY, 11560, US

(21) Appl. No.: 11/323,751

(22) Filed: Dec. 30, 2005

(51) Int. Cl. G06F 15/16

(52) U.S. Cl. 726/12

(57) ABSTRACT

Improved rule-based NAT techniques are disclosed that provide for tracking a translation address used in a first communication session across other, later communication sessions such that a firewall may process packets, i.e., make pass/reject decisions, associated with such other sessions based on state information associated with the previous session that used the translation address. This is facilitated by creating an association between the translation address and session information associated with the first communication session.

### FIELD OF THE INVENTION

The present invention relates generally to the field of data communication networks and, more particularly, to techniques for translating addresses associated with communication sessions in a network employing firewall protection.

### BACKGROUND OF THE INVENTION

In data communication networks, such as those compatible with the Internet Protocol (IP), the process of network address translation (NAT) involves replacing source and/or destination addresses of IP packets with alternate addresses as they pass through a router or firewall. In most cases, NAT allows multiple hosts on a private network to access a public network, such as the Internet, using a single public IP address. For example, this may be accomplished by replacing the private source IP addresses of the hosts by a single public IP address. The use of NAT is mainly motivated by the shortage of unique network IP addresses and, thus, provides multiple computing devices access to the Internet via a single address.

Juniper Networks of Sunnyvale, Calif., provides the NetScreen™ firewall product that performs a NAT process by translating, for all communication sessions, the source IP address of a given host to the same source IP address chosen from the single pool of available addresses. It is generally understood that the duration of a communication time period between two or more computing devices on a network is generally referred to as a communication session.

However, at least one problem with the Juniper NetScreen™ firewall approach is that there is no flexibility in the translation process in that, for all sessions associated with the same source IP address, such source IP address is translated to a pre-determined source IP address chosen from a fixed size pool that must be exactly as large as the pool of source addresses that may need to be mapped.

Cisco Systems of San Jose, Calif., provides the PIX™ firewall product that attempts to provide further flexibility in network address translation. The NAT process in the PIX™ firewall may select, in accordance with a rule, an address to be used for the translation from multiple address pools. Also, unlike the NetScreen™ firewall, the PIX™ firewall is not restricted to a translation pool of fixed size that must be exactly as large as the pool of source addresses that may need to be mapped.

However, while such above-mentioned flexibility is provided, the PIX™ firewall provides no ability to track the selected translation address across other sessions. This otherwise limits the flexibility provided by the use of multiple address pools in the PIX™ firewall, particularly with respect to communication protocols that may need to initiate sessions in either a forward direction, i.e., from an originating source to a destination, or a reverse direction, i.e., from the destination to the originating source.

### SUMMARY OF THE INVENTION

The problems with existing firewalls are overcome, in accordance with principles of the present invention, by improved rule-based NAT techniques that provide for tracking a translation address used in a first communication session across other, later communication sessions such that a firewall may process packets, i.e., make pass/reject decisions, associated with such other sessions based on state information associated with the previous session that used the translation address. This is facilitated by creating an association between the translation address and session information associated with the first communication session.

By way of example, in one aspect of the invention, a technique for processing one or more packets in a first computing device of a data communication network includes the following steps. At least one packet is obtained from a second computing device. The packet is associated with a first communication session and has an original address associated therewith. When the first communication session associated with the packet matches a rule, the original address associated with the packet is replaced with a translation address in accordance with the matching rule. An indication of association is then stored between the translation address and session information associated with the first communication session.

It is to be understood that a packet matches a rule, for example, when some information associated with the packet matches some information associated with the rule, e.g., information in the packet is the same as information in the rule, information in the packet corresponds to information in the rule, information in the packet meets one or more requirements of the rule.

Further, such indication of association may be stored as part of a mapping table, wherein an entry of the mapping table specifies a mapping between the original address and the translation address. The entry of the mapping table may include a pointer to a session state record that is linked to a mapping between the original address and the translation address.

The technique may further include obtaining a packet from a third computing device destined for the second computing device, wherein the packet from the third computing device is associated with a second communication session, and has the translation address associated therewith. At least a portion of the session information associated with the first communication session may then be accessed to determine whether the packet from the third computing device should be passed to the second computing device. In one example, the packet is passed to the second computing device when such session information indicates that the first communication session is still active, and rejected when the first communication session is not still active. However, in some situations, such packet may be passed even if the first session is no longer active. It is to be understood that the term “active” generally means that the firewall may still pass packets for that session.

Advantageously, creation of the association between the translation address and session information associated with the first communication session enables at least a portion of the session information to be accessible for consideration by the first computing device upon receipt of another packet associated another communication session, or even upon receipt of other packets associated with the first communication session. Thus, firewalls that implement the invention are better able to accommodate communication protocols that may need to initiate sessions in either a forward direction, i.e., from an originating source to a destination, or a reverse direction, i.e., from the destination to the originating source

### BRIEF DESCRIPTION OF THE DRAWINGS

FIG. 1 is a block diagram illustrating a firewall-based system in which techniques of the invention may be implemented, according to one embodiment of the invention;

FIG. 2 is a flow diagram illustrating a rule-based methodology for address translation, according to one embodiment of the invention;

FIG. 3 is a flow diagram illustrating an address selection process in a rule-based methodology for address translation, according to one embodiment of the invention;

FIG. 4 is a diagram illustrating examples rule matching and mapping treatment, according to one embodiment of the invention;

FIG. 5 is a flow diagram illustrating a reverse session rule matching process, according to one embodiment of the invention;

FIG. 6 is a diagram illustrating examples of rule matching and mapping treatment, according to another embodiment of the invention; and

FIG. 7 is a diagram illustrating a mapping table, according to an embodiment of the invention.

### DETAILED DESCRIPTION OF PREFERRED EMBODIMENTS

It is to be appreciated that while the present invention will be described below in the context of a firewall-based environment of an IP-compatible communications network, the invention is not so limited. That is, the present invention is more generally applicable to any data communication network in which it would be desirable to provide improved techniques for performing address translation in a firewall-based environment. Also, while the descriptions below refer to the translated address being a source address, principles of the invention may be applied to any address type, e.g., destination address, etc.

As will be explained in detail herein, illustrative principles of the invention provide flexibility in how different sessions from the same source address are handled. This is accomplished by specifying the behavior on a rule-by-rule basis, and providing for separate source address mappings or translations depending on the rule that was matched. Additionally, illustrative principles of the invention support the reverse mapping of sessions that are initiated in the opposite direction through the network, and tracks and forces closure of “non-reference-counted” reverse sessions when all associated forward sessions and all “reference-counted” reverse sessions using the same address mapping have terminated. This feature improves support for such protocols as X11 in which sessions may need to be initiated in either direction through the firewall.

More specifically, illustrative principles of the invention specify address mapping on a rule-by-rule basis, and each such rule names a dynamic host group in which the address mapping is recorded. This allows sessions with a given source IP address to be source-address translated using different dynamically allocated IP addresses, or not source-address translated at all, depending what has been specified in the matching rule.

Rule syntax may be provided to allow creation of rules. Such rules can create sessions in the reverse direction using existing active address mappings. Data structures for session state and host groups may be modified for efficiently identifying existing mappings and for tracking the lifetime of address mappings and terminating reverse mappings, as required for efficient and secure operation of the feature.

Further, principles of the invention may be used with one address pool or more than one address pool. If more than one address pool is used, some of the pools may be pools containing public IP addresses while others may be pools containing private IP addresses.

It is to be appreciated that the ability to specify within a rule which of two or more mapped-to pools are to be used, in accordance with the invention, provides valuable flexibility to a firewall implementation. For example, the destination address may indicate that an internal network using private addresses is the destination. For these sessions, a private address that is routable back to the firewall would be an appropriate choice. Two or more pools of public addresses can be used to provide preferential treatment to a subset of sessions because they belong to a particular set of host devices. For example, the devices competing for addresses may include mobile clients and proxy servers. The service provider may give priority to the proxy servers because they act on the behalf of multiple mobile clients. Providing a separate pool with lower blocking probability to the proxy servers will provide preferential treatment for the proxy server sessions.

Still further, since the firewall can operate as a bridge, it can be used to provide protection between different regions of the same network that share an address space. For these, no translation is necessary. Furthermore, these rules can accommodate an architecture where some network components are performing the mapping to public addresses for some subset of the hosts behind the firewall. Rules that pass the sessions using these source addresses without performing an additional mapping may be specified.

Accordingly, principles of the invention differ from existing NAT approaches, such as the NetScreen™ firewall approach, since the mapping according to the invention is not pre-determined and the pool of addresses may be smaller than the number of hosts that may originate sessions that require NAT.

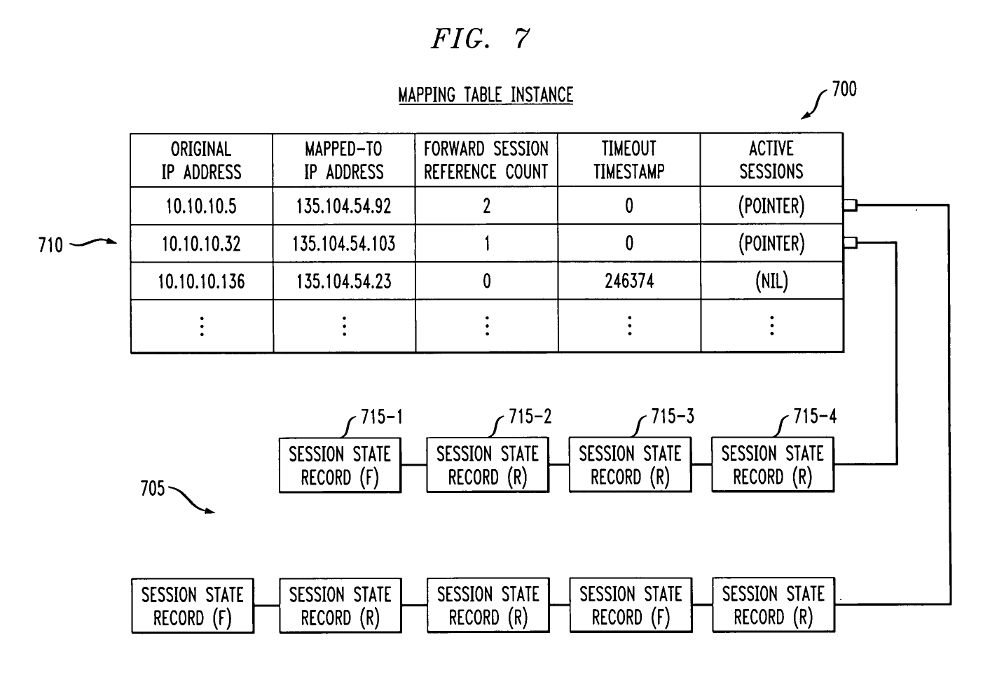

As will also be seen, creation of an association, e.g., a mapping table entry, between a translation mapping and session information associated with a given communication session (explained below in the context of FIG. 7) provides firewalls that implement principles of the invention with the ability to better accommodate communication protocols that may need to initiate sessions in either a forward direction, i.e., from an originating source to a destination, or a reverse direction, i.e., from the destination to the originating source.

It is to be understood that, in illustrative embodiments such as that shown in FIG. 7 below, “session information” refers to one or more session state records. Such records may include information necessary to identify a session such as a key. The key may represent the source and destination addresses, and source and destination ports, associated with the session. The state records may also include information on the time that the session was created and the number of bytes of data passed in the session. Further, the records may include information about a rule that was matched, as well as information relating to higher level protocols associated with the session (e.g., Voice-Over-IP). Other information about the session may also be included in such records.

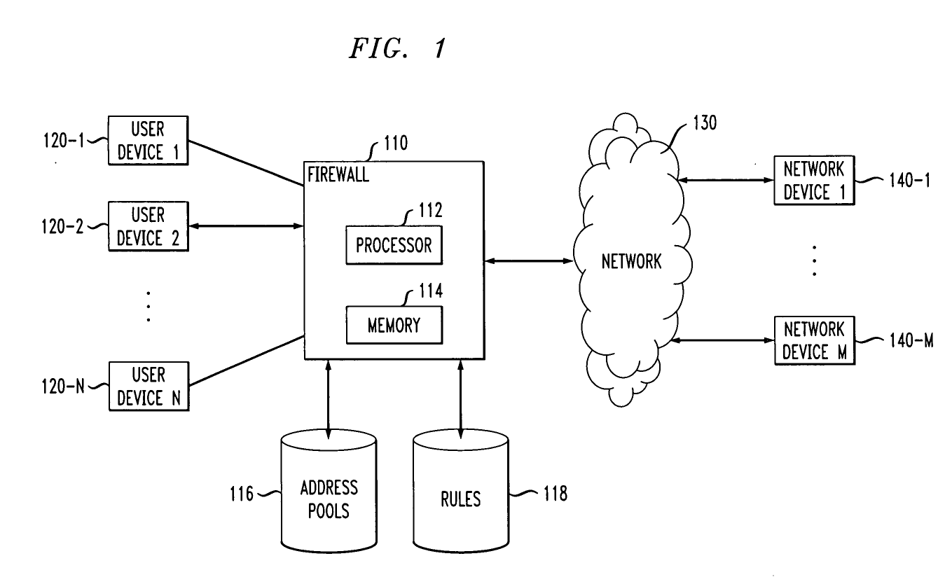

Referring initially to FIG. 1, a block diagram illustrates a firewall-based system in which techniques of the invention may be implemented, according to one embodiment of the invention.

As shown in FIG. 1, a firewall 110 is operatively coupled to user devices 120-1 through 120-N (where N represents the number of user devices in the system). User devices may, by way of example only, include data-enabled phones, personal digital assistants (PDA), or laptops. While not expressly shown, the user devices may be coupled to the firewall via a private network. Such a private network may be one associated with an organization (e.g., a company or business). By way of example only, the private network may include a wireless communication service provider's internal network. Also, it is to be understood that firewall 110 could be a router.

Firewall 110 is operatively coupled to network 130. Network 130 may represent a public network such as the Internet or World Wide Web. However, network 130 may represent a public network, a private network, or some combination of public and private network.

Firewall 110 serves as a gateway for the user devices to access network 130. It is to be appreciated that the rule-based address translation and session control methodologies of the invention are implemented on firewall 110. Also, while only one firewall is shown for simplicity, it is understood that the invention contemplates one or more such firewalls operating in the network.

Also shown in FIG. 1 are network devices 140-1 through 140-M (where M represents the number of network devices in the system). These are examples of computing devices (e.g., Web servers) which a user device 120 may be sending data to and/or receiving data from during communication sessions.

As further shown in FIG. 1, firewall 110 includes processor 112 and memory 114. Similarly, while not expressly shown, each computing device 120 or 140 may include a processor and a memory. Each computing device utilizes its processor and memory to perform steps, functions, operations, calculations, etc.

It is to be appreciated that the term “processor” as used herein is intended to include any processing device, such as, for example, one that includes a central processing unit (CPU) and/or other processing circuitry (e.g., digital signal processor (DSP), microprocessor, etc.). Additionally, it is to be understood that the term “processor” may refer to more than one processing device, and that various elements associated with a processing device may be shared by other processing devices.

The term “memory” as used herein is intended to include memory and other computer-readable media associated with a processor or CPU, such as, for example, random access memory (RAM), read only memory (ROM), fixed storage media (e.g., hard drive), removable storage media (e.g., diskette), flash memory, etc.

In addition, while not expressly shown, each computing device (firewall 110, user device 120, network device 140) may include one or more input devices (e.g., keyboard, mouse, etc.) for inputting data to the processing unit, as well as one or more output devices (e.g., CRT display, etc.) for providing results associated with the processing unit. Alternatively, inputs could be read into the system from a diskette or from some other source (e.g., another computer system) connected thereto. Also, inputs to the methodologies may be obtained in accordance with the one or more input devices. The output devices may be one mechanism for a user or other computer system to be presented with results of the methodologies of the invention.

Still further, while not expressly shown, each computing device (firewall 110, user device 120, network device 140) may include one or more components capable of allowing the computing system to communicate with other computing systems. Thus, the network interface may comprise a transceiver configured to communicate with a transceiver of another computer system via a suitable communications protocol. It is to be understood that the invention is not limited to any particular communications protocol.

Accordingly, one or more computer programs, or software components thereof, including instructions or code for performing the methodologies of the invention, as described herein, may be stored in one or more of the associated storage media (e.g., ROM, fixed or removable storage) of the memory and, when ready to be utilized, loaded in whole or in part (e.g., into RAM) and executed by the processor.

In any case, it is to be appreciated that the techniques of the invention, described herein and shown in the appended figures, may be implemented in various forms of hardware, software, or combinations thereof, e.g., one or more operatively programmed general purpose digital computers with associated memory, implementation-specific integrated circuit(s), functional circuitry, etc. Given the techniques of the invention provided herein, one of ordinary skill in the art will be able to contemplate other implementations of the techniques of the invention.

Furthermore, as shown in FIG. 1, firewall 110 is operatively coupled to address pool store 116 and rule store 118. It is from such memory stores that the firewall selects rules to determine matching, and selects addresses for use in translation. While shown separately for illustrative purposes, it is to be understood that such address pools and rules may be stored in and accessed from the firewall memory 114.

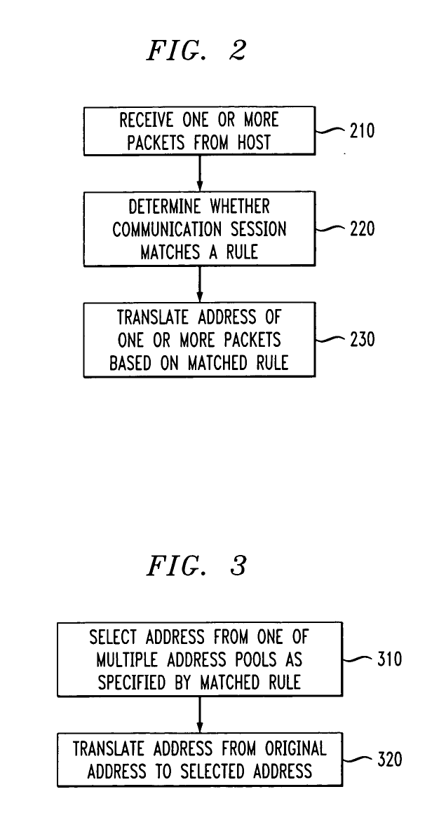

Referring now to FIG. 2, a flow diagram illustrates a rule-based methodology for address translation, according to one embodiment of the invention. It is to be appreciated that such methodology may be implemented via firewall 110 (FIG. 1).

In step 210, firewall 110 receives one or more packets from a host such as user device 120. The one or more packets are associated with a communication session, and include the source address of the originating user device.

In step 220, firewall 110 determines whether the communication session associated with the packets matches a rule. This is done by accessing rule store 118. It is assumed that the rules have been previously generated and stored. The rules may be generated in any suitable syntax. The invention is not limited to any particular syntax.

Rule matching may be accomplished in a number of ways. In one example, a session key (a unique identifier of a communication session) may be extracted from a packet. The session key is how the firewall knows that certain packets are associated with a particular communication session. Then, a rule whose session selection specification matches that session key is accessed in rule store 118. The terms of the rule are then applied to the packet. That is, in step 230, when the communication session associated with the packet matches a rule, the source address associated with the packet is translated in accordance with the matched rule.

For example, a given address mapping may be specified by the rule. Such address mapping is obtained from address pools store 116 and applied to the source address. Such process is shown in FIG. 3. That is, in step 310, an address is selected, as specified by the matched rule, from one of multiple address pools. The original source address of the subject packet is rewritten with the selected address.

The steps of FIGS. 2 and 3 are performed for packets from each of user devices 120-1 through 120-N. Thus, such translation can thus be used to enable such multiple hosts (user devices 120-1 through 120-N) on a private network to access network 130 using a single IP address. The IP address being selected from multiple pools or groups of IP addresses.

Advantageously, such a technique provides flexibility in how different sessions from the same source address are handled by specifying the behavior on a rule-by-rule basis, and providing for separate source address mappings depending on the rule that was matched. Also, the firewall is able to select, for the same host, a particular mapping for translating the source address of the host, depending on the matched rule. This is possible in accordance with principles of the invention, since such principles of the invention provide for partitioning mappings into different groups. Further, such partitioning allows a network administrator to specify both public address pools and private address pools from which an address may be selected and applied.

Also, as will be illustrated in FIG. 7, creation of a mapping table that provides a link between a translation mapping, as determined using the methods of FIGS. 2 and 3, and session information associated with a given communication session, provides firewalls that implement principles of the invention with the ability to better accommodate communication protocols that may need to initiate sessions in more than one direction.

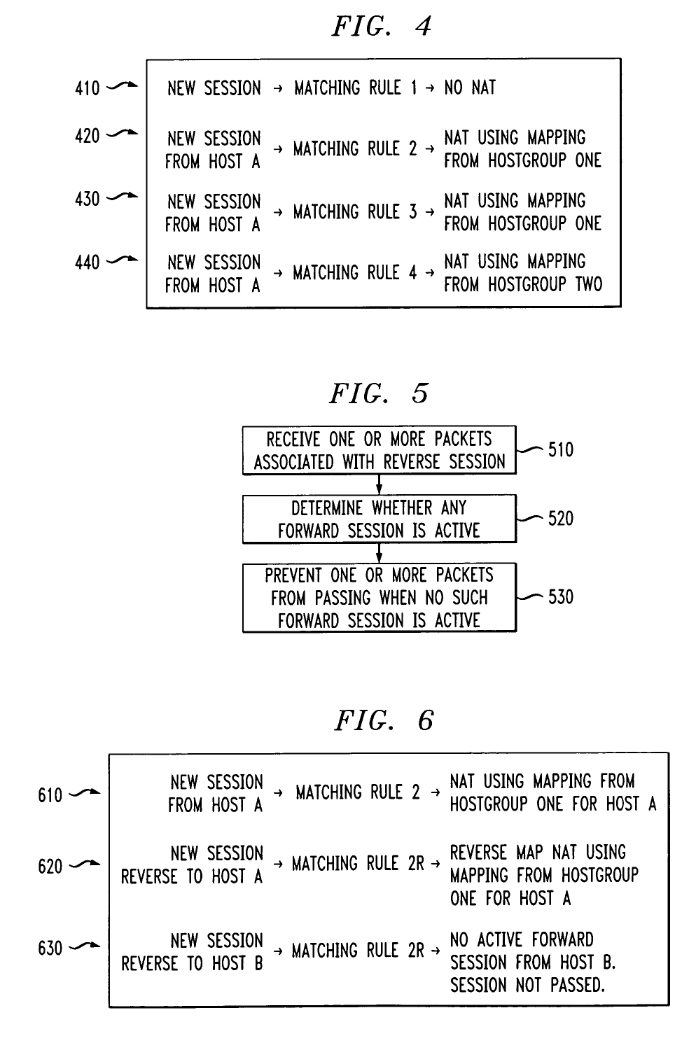

Referring now to FIG. 4, a diagram illustrates examples of rule matching and mapping treatment, according to one embodiment of the invention.

As a first example 410, it is assumed a host computing device initiates a new communication session in which packets are transmitted having the source address of the host. Firewall 110 extracts the unique session key from a packet and matches it to a rule. Assume rule 1 is identified as a match. Thus, translation is performed as per rule 1. Note that 410 shows a particular example of a situation where the rule specifies a translation instruction that applies no address translation to the packet (i.e., no NAT).

Example 420 illustrates a new session initiated from a host A, whereby matching rule 2 instructs that NAT be performed on packets using a translation mapping selected from a hostgroup one (stored with other hostgroups in store 116).

It is to be understood that a “mapping” may simply indicate which address is to replace the original source address of the packets. However, a mapping could define a more complex translation scheme.

Example 430 illustrates a new session again initiated from a host A, whereby matching rule 3 instructs that NAT be performed on packets using a translation mapping again selected from a hostgroup one.

Lastly, example 440 illustrates a new session initiated from a host A, whereby matching rule 4 instructs that NAT be performed on packets using a translation mapping selected from a hostgroup two (stored with other hostgroups in store 116).

Such above scenarios are only examples to illustrate the flexibility that is realized with such rule-based address translation principles of the invention.

Additionally, principles of the invention support the reverse mapping of sessions that are initiated in the opposite direction through the network. Such principles also permit tracking and forced closure of these reverse sessions when all associated forward sessions using the same address mapping have terminated.

Thus, with reference back to FIG. 1, it is to be appreciated that such reverse sessions may be initiated by one of network devices 140. Packets from such a session are received by firewall 110 and processed as per one or more rules indexed by the key of the reverse session. Thus, packets may or may not be passed to a user device, depending on the specifications of the matched rule.

Referring now to FIG. 5, a flow diagram illustrates a reverse session rule matching process, according to one embodiment of the invention.

As shown, in step 510, firewall 110 receives one or more packets from one of the network devices 140. The one or more packets are associated with a communication session (reverse session), and are destined for one of the user devices 120.

In step 520, firewall 110 determines whether the communication session (reverse session) associated with the packets matches a particular rule. This is again accomplished via extraction and use of a session key, as explained above. When the communication session matches the particular rule, firewall 110 determines whether a second communication session, which has a direction (i.e., forward) opposite to a direction (i.e., reverse) of the first communication session, is active.

When no such second communication session is active, in step 530, firewall 110 prevents the packets from being forwarded to the target user device. However, if such a forward session is active, the packets are passed.

Referring lastly to FIG. 6, a diagram illustrates examples of rule matching and mapping treatment, according to another embodiment of the invention. More particularly, the examples in FIG. 6 illustrate reverse mapping.

Example 610 illustrates the forward session mapping from host A in accordance with a matching rule 2. That is, firewall 110 uses a mapping from hostgroup one.

Example 620 shows a new session in the reverse direction, i.e., a session where packets are going to host A. Firewall 110 determines that a matching rule 2R should apply to these packets. Thus, a reverse mapping from hostgroup one is applied. This could involve translating the destination address of the packets, which could be a source-translated address used by the firewall for packets in example 610, to the actual address of Host A. The firewall then delivers the packets to that host.

However, example 630 shows the situation when firewall 110 determines that no forward session from a host B is active. In such case, the firewall does not pass the packets to Host B. Such a set of rules might be used to allow X11 (communication protocol) sessions from an X-Client application on a network device 140 to establish a connection to an X-Server application running in Host A, but only while there is an appropriate active forward session from Host A (e.g., a Telnet session) that matches rule 2. This might be used in conjunction with further state-dependent rule specification, as might be done using temporary rules dynamically generated by application level filters, to further qualify the reverse session. Since the state records of all active forward sessions that use the mapping in either direction can be accessed efficiently, restrictions on the establishment of the reverse direction session can be based upon the session keys and other state of the existing sessions.

Thus, advantageously, principles of the invention provide for using the state information associated with one or more of the “active-sessions-that-use-the-mapping” to restrict the establishment of the reverse direction sessions. For example, we could easily specify in the reverse rule, i.e., DYNREV, that to establish a connection from network device 140-1 to Host A, there must be an active session with a mapping in the specified host group from Host A to network device 140-1.

Given the above description of principles of the invention, the detailed description now provides a description of an illustrative service-provider-oriented embodiment. Such embodiment describes a NAT rule option that dynamically creates one-to-one mappings from source IP addresses to IP addresses allocated from a rule-specified pool (a default pool, or a pool named within the rule specification). It is to be appreciated that an address may be selected from one pool or, in an alternative embodiment, from multiple pools. When this NAT feature is specified in a rule, each source IP address will be associated with a unique IP address that is dynamically allocated from the specified pool. All of the packets of the associated session are then source-address-mapped using this pool address. Typically, the original source address will be an IP address from one of the private address ranges and the specified pool will contain public addresses owned by the service provider.

The address mappings created by a rule are retained in a dynamic hostgroup whose name is supplied in the source address translation group of the address translation tab of the rule specification. If sessions matched by different rules are to share the same address mappings, the rules should specify the same dynamic host group. These initially-empty dynamic hostgroups are created by the administrator and may be given any name. The contents of these hostgroups are maintained dynamically as sessions are created and as they terminate.

The rule may also specify that packets in the return direction are to be permitted or denied. If these packets are permitted, the destination address of these packets is replaced by the original source address of the “forward direction” of the session.

It is to be appreciated that, for the dynamic allocation NAT feature of the invention, the lifetime of the subscriber's connection (e.g., via a user device 120) to the service provider network may not be able to be reliably determined by the firewall and so can be based upon session reference counting and a timeout interval. Reference counting of sessions in the forward direction that use the mapping assures that the address allocation persists so long as the subscriber continues to maintain outbound sessions. For security reasons, sessions established in the reverse direction are generally not reference-counted and do not affect the lifetime of the allocation. Furthermore, when the lifetime of the address allocation is over, any sessions established in the reverse direction that were specified not to be reference counted in the rule used to establish the session, are forced to terminate.

The feature is enabled through NAT specifications. Two NAT types are defined, DYNFWD and DYNREV. DYNFWD is specified by placing the keyword DYNAMIC in the NAT specification in the source IP address mapping type field. DYNREV specified by placing the keyword DYNAMIC in the destination NAT address mapping type field and is used in rules that allow sessions to be established in the reverse direction of the original mapping. The mapping address field for both DYNFWD and DYNREV name a dynamic host group that represents the mapping table used to maintain Dynamic NAT address mappings. A configurable timeout interval may be used for release of an address mapping that is no longer in use by a forward session. This feature improves the performance of the system for clients that create multiple sessions over an extended period of time but may have short idle periods. The default timeout period may, for example, be one minute, but can be configured for some other time period.

The Dynamic NAT feature can be specified in a rule through a NAT specification field. The identifier string “DYNAMIC” is used in a NAT source IP address mapping type field to indicate that the DYNFWD Dynamic NAT feature is to be used. If the keyword DYNAMIC is placed in the source IP address mapping type field of the NAT specification, then the rule indicates that a source address mapping is to be applied or created if none exists. The source IP address field of the NAT specification contains a reference to a dynamic host group that is automatically maintained as mappings are created or deleted.

Mapping in the reverse direction (DYNREV) is accomplished in a rule by specifying that NAT of type DYNAMIC is to be performed on the destination address of the session. The destination IP address field of the NAT specification contains a reference to the dynamic host group that was used to create the original mapping. If no reverse mapping is found for the destination address of the packet, then the packet is dropped.

The address ranges to be used by the feature for a default address pool may be specified in a zone definition to support address mapping. To implement the multiple pool embodiment, the address pools would be normally specified within the same dynamic host group that stores the dynamically maintained mappings (the mapping table). Session source address mapping is selected by placing a dynamic host group name in the source address field for the NAT specification and using the keyword DYNAMIC in the type field for the mapping. Rules for sessions in the reverse direction to map destination IP addresses back to the original addresses are specified by placing the placing the same dynamic host group name in the destination IP address field for the NAT specification and placing the keyword DYNAMIC in the destination IP address mapping type field for the NAT specification.

When a session is created using a new or existing mapping, the session record is marked using a bit flag to signal that a DYNFWD address allocation is in use. This marking is used to assure that the reference count for the associated hostgroup data element is decremented as sessions are deleted.

When the last reference-counted session using a particular address from a pool is deleted, a timeout timestamp for the mapping is set to the current time plus a timeout interval whose value is configured globally for the zone. If, during a periodic check of the state of the dynamic host groups, it is determined that the mapping has timed out, the mapping is removed from the dynamic host group and freed. If a new session in the forward direction that uses the mapping arrives after the timeout timestamp has been set but before the mapping has been removed, the reference count for the mapping is incremented (to one) and the timeout timestamp is “cleared.”

When a packet is received that matches a rule that specifies a source IP address NAT type of DYNAMIC, the named dynamic host group (FIG. 7) is searched for a mapping for the source IP address. If such an entry is found, then the associated pool address is used for the source address mapping, the session is placed on a linked list associated with the mapping and the reference count for the mapping is incremented. If such an entry is not found, then the address pool specified by the rule is searched for an unused address. If an address is available, then the cache table for the zone is searched using the keys of the proposed forward and (if reverse is enabled) reverse sessions. If the key(s) is/are available, then the address is allocated, and the mapping is created. If a required forward or reverse session key is already in use, then the search for an available address continues. If no address is available, then the session is dropped with an appropriate alarm.

Sessions may be admitted in the reverse direction of the session that created the allocation by specifying in the rule that DYNAMIC NAT is to be performed on the destination address of the session and supplying the name of the dynamic hostgroup that was used in creating the forward session as the value of the destination IP address field of the NAT specification in the rule. In general, the reference count for the address mapping is not incremented, so that when all forward sessions that use the mapping have terminated and the associated timeout interval has expired, the session will be deleted and the mapping will be deleted. The rule may specify that the session is to be reference counted. In this case, so long as the session remains active the mapping will remain active and available for the establishment of new sessions.

Associated with each mapping is a doubly linked list of all of the sessions that use the mapping. Each session created using a DYNFWD Dynamic NAT record is removed from the linked list and the reference count for the associated mapping is decremented. When the reference count goes to zero, the timeout timestamp for the mapping is set to a non-zero value to specify the remaining life of the mapping assuming no new uses of the mapping. If the mapping is subsequently used by a new session in the forward direction, or a reference-counted session in the reverse direction, the timeout timestamp is set to zero and the reference count for the mapping is incremented.

As described above, a rule that uses the Dynamic NAT feature specifies a host group/mapping table that is to maintain the details of a source address mapping established for the sessions created by that rule. Other rules may share the same mapping table so that sessions created by those rules will share that mapping. That is, they will map the same original source address to a common mapped source address. If two different rules specify the same source address pool but a specify different mapping table, those two rules will always result in mapping the same source address into a different mapped addresses for each of the two sessions.

Host groups/mapping tables contain a single entry for each mapping. The mapping table entry will contain the original source address, the mapped-to source address, and some mechanism for efficient access to the state information for each active session that uses the mapping. Furthermore, each entry contains that information, such as reference counts, timeout timestamps, and flags that is necessary to maintain the mapping. Typically, indexing schemes are employed to provide efficient look-up of the entry using either the original or the mapped-to address.

With reference now to FIG. 7, mapping table 700 is shown as an array and the session state information 705 has been shown as a “linked list.” In practice, any data structures that supports efficient look-up of a mapping and efficient update of the mapping table entries may be employed. The operation of the feature is as follows.

Assume that a packet is received that does not match any existing session. Because no existing session is matched, the rules are searched to find a rule that matches the packet. If the matched rule specifies DYNFWD Dynamic NAT, that is, Dynamic NAT in the forward direction, then the mapping table that is specified in the rule is searched for a match of the source address of the packet to the source address associated with an entry in the mapping table. Typically, and in the implementation described, the look-up of the source address uses an index designed for efficient searching of the mapping table.

In FIG. 7, the mapping table contains an entry 710 for source address 10.10.10.10.32. When the first packet of a new session from host 10.10.10.32 is received and that packet matches a rule that specifies the mapping table in FIG. 7, then the mapping table will be searched and the entry for source address 10.10.10.32 will be located. Now, the state records 715-1 through 715-4 of all active sessions that use mapping 710 will be examined, as necessary to determine if the new session satisfies the criteria specified in the rule. If it does not, then the packet will be dropped and the session blocked. In the simplest case, no additional criteria will be required and the session will be admitted. Since the mapping was matched in the forward direction, the reference count of the entry will be incremented, and, if the reference count was initially zero, the timeout timestamp will be reset to retain/revive the mapping. A session state record for the new session will now be created, and the new session state information will be associated with the mapping table entry. In the example implementation of FIG. 7, this will result in an additional forward session being added to the list of active sessions associated with table entry.

If, instead, the address is not found in the mapping table, then a new address is allocated for the session from the address pool specified in the rule, and an entry is created in the mapping table for the new source address mapping. The reference count for the new entry will be set to one, and the state information for the new session record will be associated with the table entry.

If the matched rule specifies DYNREV Dynamic NAT, that is, Dynamic NAT in the reverse direction, then the mapping table that is specified in the rule is searched for a match of the source address of the packet to the mapped-to source address of an entry in the mapping table. If there is no such an entry, then the packet will be dropped and the session blocked. If there is such an entry, then, as required by the rule criteria, the state information of the active sessions that use the mapping will be examined to determine if the new session will be admitted. If the session is to be admitted, then the new state record for the session will be created and associated with the mapping table entry. If the rule specifies that the session is to be reference-counted, the reference count is incremented.

When the last active reference-counted session for a mapping has expired or otherwise been deleted, the reference count for the associated mapping table entry will be set to zero and the timeout timestamp for the entry will be set for some time point in the future based upon a configurable timeout interval. In FIG. 7, the last active reference-counted session for the entry associated with source address 10.10.10.136 has been deleted. Consequently the reference count for the entry is zero and the timeout timestamp has been set for some future time point. If that time point is reached before a new reference-counted session is established that uses the mapping, then the mapping will be deleted from the mapping table.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method of processing one or more packets in a first computing device of a data communication network, the method comprising the steps of:
obtaining at least one packet from a second computing device, the at least one packet being associated with a first communication session, and the at least one packet having an original address associated therewith;
when the first communication session associated with the packet matches a rule, replacing the original address associated with the at least one packet with a translation address in accordance with the matching rule; and
storing an indication of association between the translation address and session information associated with the first communication session.

2. The method of claim 1, wherein the association is stored as part of a mapping table, wherein an entry of the mapping table specifies a mapping between the original address and the translation address.

3. The method of claim 2, wherein the entry of the mapping table further comprises a pointer to a session state record that is linked to a mapping between the original address and the translation address.

4. The method of claim 1, wherein the association between the translation address and session information associated with the first communication session is employed by the first computing device to obtain for consideration at least a portion of the session information upon receipt of another packet associated with one of the set consisting of the first communication session and another communication session.

5. The method of claim 1, further comprising the steps:
obtaining a packet from a third computing device destined for the second computing device, wherein the packet from the third computing device is associated with a second communication session, and has the translation address associated therewith; and
accessing at least a portion of the session information associated with the first communication session to determine whether the packet from the third computing device should be passed to the second computing device.

6. The method of claim 5, wherein the packet is passed to the second computing device when the first communication session is active, and rejected when the first communication session is not active.

7. The method of claim 5, wherein the packet is passed to the second computing device when the first communication session is not active.

8. The method of claim 1, wherein the address useable for translation is dynamically allocated from an address group specified by the matched rule.

9. The method of claim 8, wherein the specified address group comprises a number of addresses smaller than a number of hosts that may originate sessions that utilize address translation.

10. The method of claim 8, wherein the specified address group may be specified from two or more address groups.

11. The method of claim 10, wherein one of the address groups is a public address group.

12. The method of claim 10, wherein one of the address groups is a private address group.

13. The method of claim 1, wherein the step of translating the address associated with the at least one packet in accordance with the matched rule comprises applying no translation to the address.

14. The method of claim 1, wherein the first computing device comprises a firewall.

15. The method of claim 1, wherein the first computing device comprises a router.

16. The method of claim 1, wherein the second computing device comprises a host computing device.

17. The method of claim 1, wherein the address associated with the at least one packet comprises a source address.

18. Apparatus for processing a packet in a first computing device of a data communication network, comprising:
a memory; and
at least one processor coupled to the memory and operative to: (i) obtain at least one packet from a second computing device, the at least one packet being associated with a first communication session, and the at least one packet having an original address associated therewith; (ii) when the first communication session associated with the packet matches a rule, replacing the original address associated with the at least one packet with a translation address in accordance with the matching rule; and (iii) store an indication of association between the translation address and session information associated with the first communication session.

19. Apparatus for processing a packet in a data communication network, comprising:
a firewall operative to: (i) obtain at least one packet from a second computing device, the at least one packet being associated with a first communication session, and the at least one packet having an original address associated therewith; (ii) when the first communication session associated with the packet matches a rule, replacing the original address associated with the at least one packet with a translation address in accordance with the matching rule; and (iii) store an indication of association between the translation address and session information associated with the first communication session.

20. Apparatus for processing one or more packets in a first computing device of a data communication network, comprising:
means for obtaining at least one packet from a second computing device, the at least one packet being associated with a first communication session, and the at least one packet having an original address associated therewith;
when the first communication session associated with the packet matches a rule, means for replacing the original address associated with the at least one packet with a translation address in accordance with the matching rule; and
means for storing an indication of association between the translation address and session information associated with the first communication session.

21. A method of processing a packet in a first computing device of a data communication network, comprising the steps of:
obtaining at least one packet from a second computing device, the at least one packet being associated with a first communication session, and being destined for a third computing device;
determining whether the first communication session associated with the packet matches a particular rule;
when the first communication session matches the particular rule, determining whether a second communication session, which has a direction opposite to a direction of the first communication session, is active; and
when no such second communication session is active, preventing the at least one packet from being forwarded to the third computing device.
